(19) United States
(12) Patent Application Publication
(10) Pub. No.: US 2007/0178347 A1
(43) Pub. Date: Aug. 2, 2007

(54) Coolant bypass for fuel cell stack

(76) Inventors: James S. Siepierski, Williamsville, NY (US); Martin M. Hoch, Webster, NY (US); Matthew J. Beutel, Webster, NY (US); Lee C. Whitehead, Middleport, NY (US)

Correspondence Address: CARY W. BROOKS;General Motors Corporation, Mail Code 482-C23-B21, P.O. Box 300, Detroit, MI, 48265-3000, US

(21) Appl. No.: 11/341,284

(22) Filed: Jan. 27, 2006

(51) Int. Cl. H01M 8/04

(52) U.S. Cl. 429/24; 429/26; 429/13

(57) ABSTRACT

A heat regulating system for an electrochemical conversion assembly. In one embodiment, the electrochemical conversion assembly is a fuel cell, and the device includes one or more fluid-manipulating components to vary the amount of a coolant or related heat regulating fluid used to maintain a preferred temperature in the fuel cell. Preferred fuel cell operating temperatures can be more easily achieved by selectively bypassing a portion of the coolant around the fuel cell during certain temperature or power demand regimes. A controller can be used to monitor and selectively vary the extent to which at least one of these components modifies the flow of fluid past the fuel cell.

### BACKGROUND OF THE INVENTION

The present invention relates generally to ways to selectively route coolant during operation of a fuel cell, and more particularly to bypassing at least a portion of the coolant around the fuel cell during cold start-up conditions.

In many fuel cell systems, hydrogen or a hydrogen-rich gas is supplied through a flowpath to the anode side of a fuel cell while oxygen (such as in the form of atmospheric oxygen) is supplied through a separate flowpath to the cathode side of the fuel cell. An appropriate catalyst ionizes the two reactants such that the ionization and subsequent combination of the reactants produces electric current with heat and water vapor as reaction byproducts. In one form of fuel cell, called the proton exchange membrane (PEM) fuel cell, an electrolyte in the form of a membrane is sandwiched between two electrode plates that make up the anode and cathode. This layered structure of membrane sandwiched between two electrode plates is commonly referred to as a membrane electrode assembly (MEA), and forms a single fuel cell. Many such single cells can be combined to form a fuel cell stack, increasing the power output thereof. Channels integrated into or formed between the plates can be used to convey coolant (such as water) to keep the temperature of an operating fuel cell within prescribed limits.

Unfortunately, the presence of this coolant, which is essential to durability of the fuel cell during normal operating conditions, can inhibit proper fuel cell operation when the fuel cell system is cold, such as during start-up in an extremely cold environment For example, ambient temperatures during winter may be at or below minus 20 degrees Fahrenheit; by having the substantial entirety of available coolant flow pass through the fuel cell stack during such cold conditions, attainment of a preferred fuel cell operating temperature (which, for a PEM fuel cell, is approximately eighty five degrees Celsius) can be delayed, making efficient system operation difficult. Existing coolant bypass schemes typically rely on selectively circulating the majority (if not the substantial entirety) of the coolant through a radiator or related heat exchange mechanism, depending upon the amount of coolant needed in the fuel cell. Such approaches, in addition to exacerbating system complexity, tend to hamper the ability of the fuel cell to reach its proper operating temperature, as the quenching action of a relatively large body of coolant (especially when one or both of the coolant and the ambient atmosphere are at very cold temperatures) being circulated past hot portions of the fuel cell never permits the fuel cell to attain its desired operating temperature.

Accordingly, there exists a need for a fuel cell design and mode of operation to facilitate quick start-up of fuel cell-powered devices that are exposed to extremely cold temperatures. There further exists a need for a way to selectively route coolant through a fuel cell to effect such quick start-up.

### BRIEF SUMMARY OF THE INVENTION

These needs are met by the present invention, wherein an electrochemical conversion assembly (such as a fuel cell system) and a method of operating the assembly that incorporates the features discussed below is disclosed. In accordance with a first aspect of the present invention, a fuel cell assembly includes at least one fuel cell and a fluid conveying circuit cooperative with the fuel cell. The fuel cell includes an anode configured, a cathode and a membrane disposed between the anode and cathode. A first reactant (for example, a hydrogen-bearing compound or related reductant) can be introduced into the anode, while a second reactant (for example, an oxygen-bearing compound or related oxidant) can be introduced into the cathode, while the membrane allows an ionized portion of the first reactant to pass from the anode to the cathode so that the two reactants can combine at the cathode. The circuit includes a temperature-regulating flowpath and a bypass flowpath, the former to carry a first portion of a fluid (for example, water) resident in the circuit past the fuel cell in such a way that a heat exchange relationship can be set up between the fluid and the heat generated in the fuel cell by the oxidant-reductant reaction, the latter fluidly parallel to the former and capable of selectively carrying a second portion of the fluid around (i.e., removed from) the fuel cell. In this way, the second portion is substantially thermally decoupled from the fuel cell such that it does not appreciably contribute to heat exchange or related thermal interaction with the fuel cell while flowing through the bypass flowpath part of the circuit. The division of fluid flow between the first and second portions is a function of at least one of an ambient temperature, a temperature within the fuel cell and a load on the fuel cell. The circuit also includes one or more devices for promoting the circulation of the fluid through the circuit.

Optionally, the device for promoting the circulation of the fluid through the circuit includes a pump and a valve. In a preferred configuration, the temperature-regulating and bypass flowpaths of the circuit flow through common conduit between the pump discharge and the point where the two flowpaths bifurcate, as well as at a point where the two flowpaths reconvene downstream of the fuel cell until the pump inlet. Other optional features include a supplemental heating device, such as a heat exchanger to reduce or increase the temperature of the coolant being used to pass through the fuel cell. In one form, the heat exchanger can be placed along the circuit, and can be a resistive heating element (powered, for example, by electricity generated during the reaction in the fuel cell, or by a separate catalytic reaction, or by an in situ catalytic reaction of hydrogen and oxygen at the cathode). Other forms of heating are also available; for example, when the fuel cell is employed in a vehicular or other mobile application, waste heat generated by other on-board systems (such as a braking system) can be used to heat up the fluid circulating in the circuit. In addition, supplemental heating may be produced directly by catalytic burning (either in the fuel cell or in a separate combustor).

The assembly may further include an inlet manifold disposed downstream of the pump and upstream of the fuel cell. The inlet manifold can deliver fluid flowing through the circuit into the first and second portions, and an outlet manifold disposed downstream of the fuel cell, the outlet manifold configured to receive fluid flowing through the first and second portions and deliver the fluid to the pump. In addition to the aforementioned pump and valve, the assembly may further include one or more temperature sensors to detect temperatures within the fuel cell, ambient environment in which the assembly is situated, or both. A controller may be used to automate operation of the fluid conveying circuit. In one form, the controller is responsive to signals sent from the one or more temperature sensors, and can send output signals to actuate the pump, valve or other components used to operate the circuit in general, and the bypass flowpath in particular. An example of such a controller could be a programmable logic controller. A load sensor may also be included such that upon attainment of a predetermined load condition (for example, a low load condition), the controller can manipulate the valve of the bypass flowpath even if the temperature of the fuel cell is high enough to ordinarily not warrant bypass flow. In a preferred embodiment, the temperature-regulating flowpath and the bypass flowpath are in fluid communication with one another. In this way, they share a common flowpath for at least a portion of the circuit. In particular, the portion of the circuit that is between the pump outlet and the split between the bypass flowpath and the temperature-regulating flowpath, as well as the portion that commences where the bypass flowpath and the temperature-regulating flowpath reconvene and ends at the pump inlet, are common. Fluid and thermal mixture occurs in these common portions of the circuit. In another option, a vehicle may incorporate the fuel cell as a source of motive power for the vehicle. A representative (although not exhaustive) list of vehicles that can be powered by the fuel cell assembly of the present invention include cars, trucks, aircraft, watercraft, motorcycles or the like.

According to another aspect of the invention, an electrochemical conversion assembly is disclosed. Particularly, the electrochemical conversion assembly can be a fuel cell, where even more particularly, it may be a PEM fuel cell. While it has been mentioned that one type of fuel cell that can benefit from the present invention is the PEM fuel cell, it will be appreciated by those skilled in the art that the use of other fuel cell configurations is also within the purview of the present invention. The electrochemical conversion assembly includes a plurality of anodes each configured to transport a first reactant, a plurality of cathodes each configured to transport a second reactant, and a membrane electrode assembly disposed between each of the anodes and cathodes such that together the anodes, cathodes and membranes define a stack. The assembly further includes a coolant system configured to regulate the temperature produced in the assembly by a reaction between the reactants. Features of the coolant system include a coolant inlet manifold and a coolant outlet manifold, the first configured to deliver at least a portion of a coolant between the anodes and cathodes, and the second configured to receive at least a portion of the coolant between the anodes and cathodes. The manifolds are in fluid communication with one another. The system also includes a coolant flowpath that allows coolant to flow in and around the stack. The coolant flowpath is broken up into a temperature-regulating flowpath and a bypass flowpath, where the first is configured to convey a first portion of the coolant through the stack such that the portion of coolant flowing past the stack elements (for example, stack anodes and cathodes) is in thermal communication with these elements, and where the latter is fluidly parallel to the temperature-regulating flowpath and configured to selectively convey a second portion of the coolant around the stack. In this configuration, the second portion is substantially thermally decoupled from the stack, taking no part in removing heat therefrom. The division of flow between the first and second portions is a function of at least one of an ambient temperature and a temperature within the stack such that during certain operating conditions (such as cold start during cold ambient conditions), the flow through the assembly is reduced to avoid overly quenching any heat produced during the oxidant-reductant reaction. The assembly also includes a pump and one or more valves fluidly coupled to the coolant flowpath to circulate the coolant, as well as a controller cooperative with the pump and the valve(s) such that upon attainment of certain conditions, the controller can direct the pump, valve(s) or both to effect the selective conveyance of the second portion through the bypass flowpath. Examples of such conditions include a predetermined load on the stack, a predetermined temperature within the assembly, or a predetermined temperature within the ambient environment, as well as combinations of any or all of these three. The controller may be signally coupled to one or more parameter measuring elements, include temperature sensors, pressure sensors, mass flow sensors, load sensors or the like such that the controller is responsive to these sensed parameters. In one preferred (although not necessary) embodiment, the controller is a programmable logic controller.

In another option, the electrochemical conversion assembly is part of a vehicle such that the fuel cell is a source of motive power. Even more particularly, the vehicle may include a platform configured to carry the source of motive power, a drivetrain rotatably connected to the platform such that the drivetrain is responsive to output from the source of motive power, and numerous wheels connected to the drivetrain.

According to another aspect of the invention, a method of operating a fuel cell system is disclosed. The method includes configuring at least one fuel cell to comprise an anode, a cathode, an electrolyte disposed between the anode and the cathode, and a heat regulating circuit configured to flow a heat regulating fluid through the fuel cell. With such a fuel cell configuration, the method further includes sensing at least one of an ambient temperature, a temperature within the fuel cell or a load on the fuel cell, manipulating a flow regulating device upon attainment of a threshold value of the selected one or more of these parameters, and introducing a reductant into the anode and an oxidant into the cathode so that the fuel cell operates to produce electricity. In addition to the flow regulating device that is fluidly coupled to the circuit, the circuit is made up of a conduit defining a common flowpath, a coolant flowpath and a bypass flowpath.

In one optional form, the flow regulating device includes a pump and at least one valve. The valve is placed in the conduit in a location to selectively permit a flow of the heat regulating fluid through the bypass flowpath. In one form, it can be placed within a fuel cell stack above the fuel cells. The manipulation of the flow regulating device may include operating the pump to adjust a rate of flow of the heat regulating fluid through the circuit, adjusting the valve, or both. As is evident from the configuration of the system, while the need to bypass the heat regulating fluid (i.e., coolant) around the fuel cell exists during such times as the temperature of the ambient environment, the fuel cell or both is at or below a predetermined value, it may also be necessary to bypass the fluid around the fuel cell during times where the ambient and/or fuel cell temperature is high, but the power demand on the fuel cell is low (such as during fuel cell idle or related low-load circumstances). To promote the rapid heating of the stack and the heat regulating fluid during cold start and related cold conditions, a supplemental heater can be included such that by its operation, the temperature of the heat regulating fluid flowing through the circuit is increased. In one form, the supplemental heater is a resistive heater, while in another it is a catalytic burner. As previously discussed, this burner could be either a part of the already-existing fuel cell or a separate device with its own oxidant and reductant supply.

### BRIEF DESCRIPTION OF THE SEVERAL VIEWS OF THE DRAWINGS

The following detailed description of the present invention can be best understood when read in conjunction with the following drawings, where like structure is indicated with like reference numerals and in which:

FIG. 1 shows a block diagram of a fuel cell system configured for vehicular application;

FIG. 2 shows a coolant delivery system according to an embodiment of the present invention;

FIG. 3 shows an alternate embodiment of a portion of the coolant delivery system of the present invention elevation, where a flow control valve is disposed in the flowpath; and

FIG. 4 shows a vehicle employing the fuel cell system of the present invention.

### DETAILED DESCRIPTION OF THE PREFERRED EMBODIMENTS

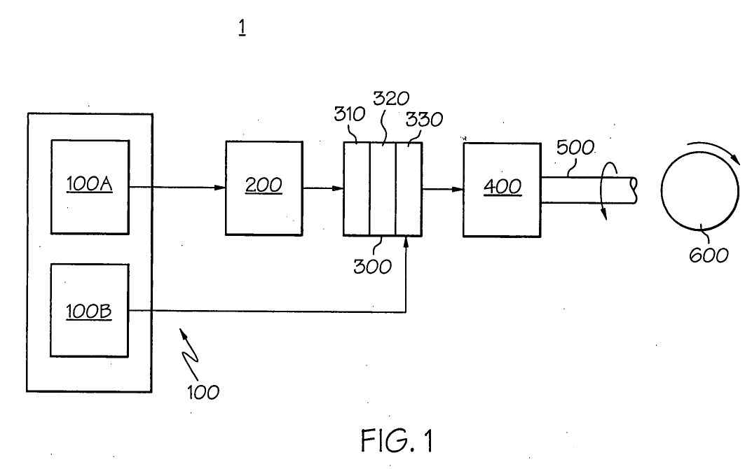

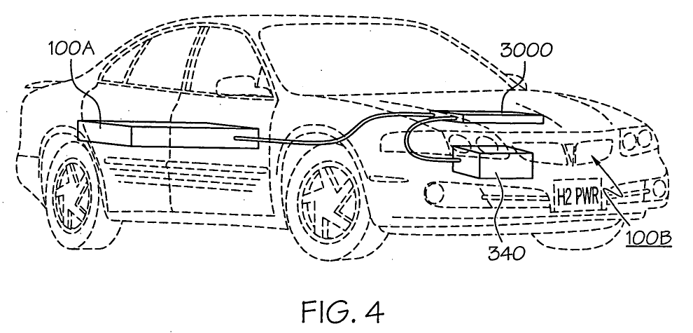

Referring initially to FIGS. 1 and 4, a block diagram highlights the major components of a mobile fuel cell system 1 according to the present invention, as well as a representative placement of a fuel cell system into an automotive application. Referring with particularity to FIG. 1, the system 1 includes a reactant delivery system 100 (made up of fuel source 100A and oxygen source 100B), fuel processing system 200, fuel cell 300, one or more energy storage devices 400, a drivetrain 500 and one or more motive devices 600, shown notionally as a wheel. While the present system 1 is shown for mobile (such as vehicular) applications, it will be appreciated by those skilled in the art that the use of the fuel cell 300 and its ancillary equipment is equally applicable to stationary applications. It will further be appreciated by those skilled in the art that the term “fuel cell”, while generally indicative of a single fuel cell within a larger stack of such cells, may also be used to define the stack. Such usage will be clear, based on the context.

The fuel processing system 200 may be incorporated to convert a raw fuel, such as methanol into hydrogen or hydrogen-rich fuel for use in fuel cell 300; otherwise, in configurations where the fuel source 100A is already supplying substantially pure hydrogen, the fuel processing system 200 may not be required. The energy storage devices 400 can be in the form of one or more batteries, capacitors, electricity converters, or even a motor to convert the electric current coming from the fuel cell 300 into mechanical power such as rotating shaft power that can be used to operate drivetrain 500 and one or more motive devices 600.

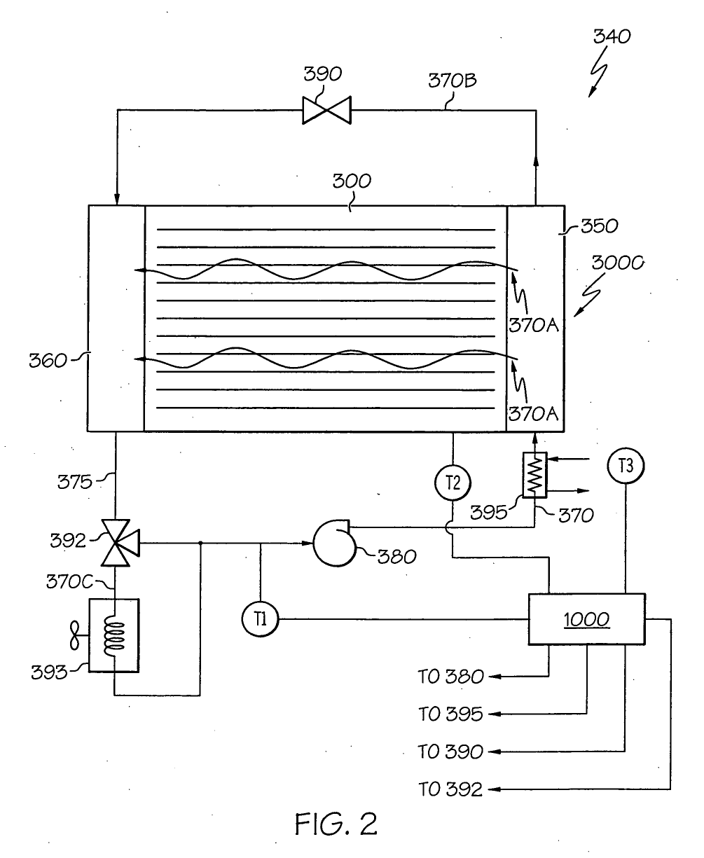

Fuel cell 300 includes an anode 310, cathode 330, and an electrolyte layer 320 disposed between anode 310 and cathode 330. Preferably, the anode 310 and cathode 330 are arranged as bipolar plates, and allow respective diffusion of fuel and oxygen, as well as the flow of water that forms as a result of the fuel-oxygen reaction at the cathode 330. The electrolyte layer 320, shown presently in the form of a proton exchange membrane, is placed between each of the anode 310 and cathode 330 to allow the ionized hydrogen to flow from the anode 310 to the cathode 330 while inhibiting the passage of electrical current therethrough. Fuel (typically in the form of gaseous hydrogen) comes in contact with a catalyst (such as platinum or a related noble metal) on the anode 310. Electrochemical oxidation of the hydrogen fuel proceeds by what is believed to be a dissociate adsorption reaction facilitated by the catalyst. The positively-charged hydrogen ion (proton) produced at the anode 310 then passes through the electrolyte 320 to react with the negatively-charged oxygen ions generated at the cathode 330. The flow of liberated electrons from the ionization of the fuel sets up a current through an external circuit that may include the energy storing devices or other load 400 such that a motor or related current-responsive device may be turned. Although only a single fuel cell 300 is shown in FIG. 1, it will be appreciated by those skilled in the art that fuel cell system 1 (especially those for vehicular and related applications) may be made from a stack 3000 (shown in FIGS. 2 through 4) of such cells serially connected.

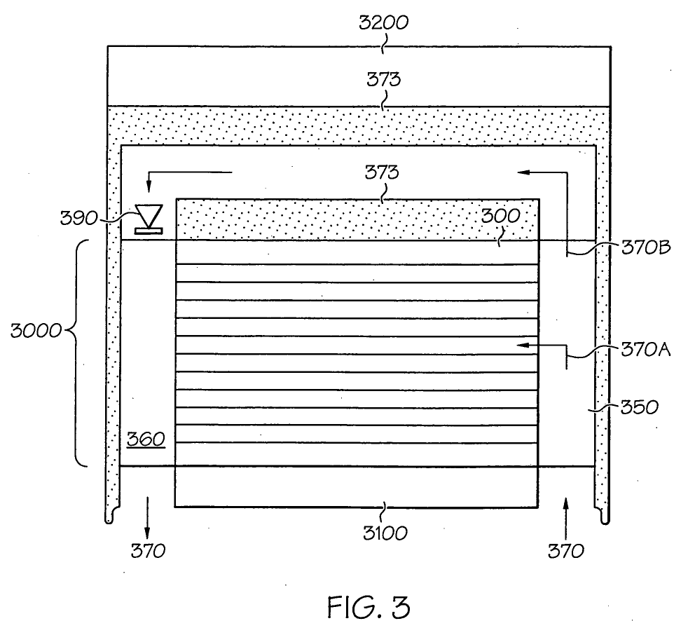

Referring next to FIGS. 2 and 3, a block diagram showing the fluid connections between a fuel cell stack 3000 and a coolant delivery system 340 is shown. The system uses a circuit 370 with parallel branches making up a temperature-regulating flowpath 370A and a bypass flowpath 370B. An additional radiator flowpath 370C also forms a branch, and is as will be discussed below, used once the stack 3000 has reached its normal operating temperature. In a preferred embodiment of the system 340, electrical power generated by the electrochemical reaction of hydrogen and oxygen produces heat and water at the cathode of each fuel cell 300 within stack 3000. Headers 350, 360 form a respective inlet and outlet on stack 3000, and act as a manifold to distribute coolant via flowpath 370A past the individual plates of the fuel cells 300, as well as away from the fuel cells 300 through bypass flowpath 370B. Conduit 375 and pump 380 are used to transport the fluid through the circuit 370, while at least one valve 390 or related selective flow device is used to control the flow between the temperature-regulating flowpath 370A and bypass flowpath 370B. In one form, the valve 390 is a passive, autonomous device, such as a thermally-controlled valve (for example, a thermostat), while in another it can be an electromechanically controlled valve. The terms “flow regulating device” is understood to describe one or more of the components used to control the flow of coolant or related fluid through the circuit 370; the context will dictate which of the components are being referred to. Importantly for the present disclosure, while the fluid flowing through circuit 370 can be used for cooling of fuel cell 300 and stack 3000 (as evidenced by the presence of aforementioned radiator flowpath 370C), it may also function as a temperature-increasing fluid, depending upon the circumstances. This is particularly valuable in cold start conditions (i.e., where the fuel cell assumes or approaches the local, ambient environment temperature after not having been operated for a while, and where the ambient condition includes cold temperatures), as the fuel cell stack bypass can manipulate coolant flow in such a way as to avoid having the coolant itself function as a large heat sink that would quench all of the heat generated by the electrochemical reaction within the stack 3000.

As stated above, the circuit 370 is further divided into the coolant (i.e., heat-regulating) flowpath 370A, the bypass flowpath 370B and a radiator flowpath 370C. It is the first two of these flowpaths that are especially valuable in cold start conditions, as the coolant flowpath 370A allows fluid to flow past the plates of the fuel cells 300 to pick up reaction heat therefrom, while the bypass flowpath 370B, which includes flow regulating device 390, can be used in conjunction with pump 380 to selectively allow the flow of fluid disposed in the circuit. Radiator flowpath 370C is used once the stack 3000 has reached its normal operating conditions, and includes a three-way valve 392 (which can be, for example, a thermostat as found in conventional automotive radiator systems) that can allow the coolant to flow through radiator 393 (shown with an optional fan) to be cooled. The coolant pump 380 may include variable speed features to allow it to deliver coolant at different quantities.

A controller 1000 (such as a programmable logic controller) can be used in conjunction with temperature sensors T1, T2 and T3, flow sensors (not shown) or the like to monitor coolant delivery system 340 parameters and send out appropriate commands on an as-needed basis to adjust operation of the system 340. For example, when the ambient temperature falls below a predetermined threshold, such temperature can be sensed (for example, by T3) and, when compared against the logic stored in the controller 1000, can be used to dictate a prescribed course of manipulations of the pump 380, valve 390, valve 392 or any combination thereof in order to effect temperature regulation of the stack 3000. In the alternative, valves 390 and 392 could be stand-alone mechanically (i.e., spring) actuated devices that do not require signal-based actuation from controller 1000.

Furthermore, a supplemental heating device 395 may be thermally coupled to conduit 375 to introduce additional heat during certain operational conditions. By placing the supplemental heating device 395 near the inlet header 350, the amount of cold fluid acting as a heat sink for the heat generated in stack 3000 is advantageously kept to a minimum. As with the pump 380 and valve 390, the supplemental heating device 395 can be coupled to the controller 1000 such that the temperature of the coolant and the stack 3000 can be brought up quickly during cold conditions, such as cold start.

Having described the individual components that make up the coolant delivery system 340, the operation of the system may now be discussed. During cold start of the stack 3000 under subzero cold ambient conditions, operation of coolant delivery system 340 can be initiated by having valve 390 that is disposed in the bypass flowpath 370B be open, thereby allowing as much of the coolant disposed in circuit 370 to shunt around the stack 3000 as possible. Once stack loading begins, the speed of the pump 380 can be varied to achieve a predetermined stack coolant flow (or pressure drop) through flowpath 370A suitable for the initial startup temperature condition (as measured, for example, inside the stack 3000 by T2 or in the coolant by T1). For subzero startup conditions, the supplemental heating device 395 would be activated to provide additional heat to the coolant flowing into the inlet header 350. As the stack and the coolant warmup proceed, valve 390 can start to close in response to the increasing temperature, and pump 380 speed can be varied to maintain the proper stack pressure drop suitable for the load on the stack and the coolant temperature entering header 350. In one operational embodiment, valve 390 can be made to go from fully open at coolant temperatures below 0 degrees Celsius to completely closed in the range of approximately 20 to 40 degrees Celsius. Once valve 390 is closed, conventional coolant pump and stack temperature control algorithms can resume. Likewise, supplemental heating of the coolant with heating device 395 would likely be terminated at coolant temperatures above 0 degrees Celsius to avoid fuel economy penalties associated with its continued use. Once normal stack operating temperatures have been attained, such as above approximately 60 degrees Celsius, the bias in valve 392 allows it to open, thereby permitting at least a portion of the coolant previously only flowing in flowpaths 370A and 370B of circuit 370 to be circulated through radiator flowpath 370C to ensure adequate cooling of the fluid. In another operational embodiment, valve 390 can be made to open even when the stack 3000 is operating at or near normal temperatures. For example, if the demand on stack 3000 is low (such as, in an automotive application, where the vehicle is at idle or a low power cruise condition), it is possible that the capacity of pump 380 and circuit 370 is such that even at its lowest throughput condition, it is conducting away too much heat through coolant flowpath 370A, thereby hampering the ability of the air in the cathode flowpath to absorb and carry away the product water formed by the electrochemical reaction at the cathode. In such an operational embodiment, it would be advantageous for the valve 390 to be responsive to input from the controller 1000, which in turn can be responsive to one or more parameter-measuring sensors.

The cooling medium may be water, glycol or any suitable heat transfer fluid. By having the coolant capable of selective parallel flow through the bypass flowpath 370B and stack 3000, quicker heating of the stack 3000 during start-up can be realized. This configuration, where the bypass flowpath 370B is situated downstream of the inlet header 350 rather than upstream of it, is believed to be superior by ensuring adequate flow through the stack 3000 under all operating conditions. Thus, the configuration depicted in FIG. 2 means that a larger portion of the heat generated by the operation of stack 3000 returns to the inlet header 350, which is valuable in situations where there is a relatively low flow rate (which may be helpful in avoiding the overcooling of the stack flowpath 370A). While it will be appreciated by those skilled in the art that the bypass flowpath could be placed upstream of the inlet header 350, such approach could result in a significantly longer time that subzero coolant enters the stack plates, and that under such a configuration (not shown) may require additional control to avoid overcooling during cold operating conditions, which if it occurs, could entail performance penalties. The bypass flowpath 370B significantly reduces the coolant pressure drop across the stack 3000 while maintaining a relatively high circulating flow rate through the stack headers 350 and 360. In one form, the ratio of flow rates between flowpaths 370B and 370A can be between five and ten to one. The low stack pressure drop provides a relatively low coolant flow rate through flowpath 370A to avoid overcooling the stack 3000 while it is warming up. As the coolant flows slowly through the stack plates, it is warmed by stack waste heat and is discharged into the coolant outlet header 360. The warmed coolant mixes with the recirculating header flow and quickly returns warmed coolant into inlet header 350. The combination of low coolant flow rate across the stack plates and a relatively high recirculating flow makes effective utilization of stack waste heat to quickly warm the inlet coolant above 0 degrees Celsius, thereby reducing potential cold quench effects and avoiding icing problems within stack 3000.

Referring with particularity to FIG. 3, valve 390 may be embedded within stack 3000 such that it is placed in circuit 370 to regulate the flow of coolant through bypass flowpath 370B. As shown the stack 3000 includes a lower end base plate 3100 and an upper end base plate 3200. Insulator plates 373 surround the bypass flowpath 370B, and keep both the flowpath and the end cells of stack 3000 thermally insulated from large external thermal masses. While the stack 3000 is presently shown with the individual fuel cells 300 situated in a generally horizontal configuration, it will be appreciated by those skilled in the art that a vertically-oriented configuration (or some orientation between horizontal and vertical) could be employed.

While certain representative embodiments and details have been shown for purposes of illustrating the invention, it will be apparent to those skilled in the art that various changes may be made without departing from the scope of the invention, which is defined in the appended claims.

What is claimed is:

1. A fuel cell assembly comprising:
at least one fuel cell comprising:
an anode configured to accept a first reactant therein;
a cathode configured to accept a second reactant therein;
a membrane disposed between said anode and cathode, said membrane configured to allow an ionized portion of said first reactant to pass therethrough on its way from said anode to said cathode;
a fluid conveying circuit cooperative with said at least one fuel cell, said circuit comprising:
a temperature-regulating flowpath configured to convey a first portion of a fluid flowing in said circuit past said at least one fuel cell such that said first portion is in thermal communication therewith;
a bypass flowpath fluidly parallel to said temperature-regulating flowpath and configured to selectively convey a second portion of said fluid around said at least one fuel cell such that said second portion is substantially thermally decoupled therefrom, wherein the ratio of flow of said first and second portions is a function of at least one of an ambient temperature, a temperature within said fuel cell and a load demand on said fuel cell; and
at least one device for promoting the circulation of said first and second portions through said circuit.

2. The assembly of claim 1, wherein said at least one device for promoting the circulation of fluid comprises a valve disposed in said bypass flowpath and a pump.

3. The assembly of claim 2, further comprising an inlet manifold disposed downstream of said pump and upstream of said fuel cell, said inlet manifold configured to deliver fluid flowing through said circuit into said first and second portions, and an outlet manifold disposed downstream of said fuel cell, said outlet manifold configured to receive fluid flowing through said first and second portions and deliver said fluid to said pump.

4. The assembly of claim 1, further comprising a supplemental heating device disposed in thermal communication with said circuit.

5. The assembly of claim 4, wherein said supplemental heating device comprises a resistive heater.

6. The assembly of claim 4, wherein said supplemental heating device comprises a catalytic burner.

7. The assembly of claim 2, further comprising a temperature sensor configured to detect the temperature of at least one of a temperature within said fuel cell or a temperature of an ambient environment in which said assembly is situated.

8. The assembly of claim 7, further comprising a controller responsive to said signals sent from temperature sensor, said controller cooperative with at least one of said pump and said valve to selectively increase or decrease the flow of said fluid to said bypass flowpath.

9. The assembly of claim 8, further comprising a load sensor signally coupled to said controller.

10. The assembly of claim 1, wherein said temperature-regulating flowpath and said bypass flowpath are in fluid communication with one another.

11. A vehicle comprising the fuel cell assembly of claim 1, wherein said fuel cell assembly serves as a source of motive power for said vehicle.

12. An electrochemical conversion assembly comprising:
a plurality of anodes each configured to transport a first reactant therethrough;
a plurality of cathodes each configured to transport a second reactant therethrough;
a membrane electrode assembly disposed between each of said anodes and cathodes such that together said anodes, cathodes and membranes define a stack; and
a coolant system configured to regulate the temperature produced in said assembly by a reaction between said first and second reactants, said coolant system comprising:
a coolant inlet manifold configured to deliver at least a portion of a coolant between said anodes and cathodes;
a coolant outlet manifold configured to receive at least a portion of said coolant between said anodes and cathodes, said fluid outlet manifold in fluid communication with said coolant inlet manifold;
a coolant flowpath configured to regulate a temperature within said stack, said coolant flowpath comprising:
a temperature-regulating flowpath configured to convey a first portion of said coolant past said stack such that said first portion is in thermal communication therewith; and
a bypass flowpath fluidly parallel to said temperature-regulating flowpath and configured to selectively convey a second portion of said coolant around said stack such that said second portion is substantially thermally decoupled therefrom, wherein the division of flow between said first and second portions is a function of at least one of an ambient temperature, a temperature within said stack and a load demand on said stack;
a pump fluidly coupled to said coolant flowpath to circulate said coolant therethrough;
at least one valve disposed in said bypass flowpath to permit said selective conveyance of said second portion therethrough; and
a controller cooperative with said pump and said valve such that upon attainment of at least one of a predetermined temperature or load condition, said controller actuates at least one of said valve or said pump to effect said selective conveyance of said second portion through said bypass flowpath.

13. The assembly of claim 12, wherein said electrochemical conversion assembly is a fuel cell.

14. The assembly of claim 13, wherein said fuel cell is a proton exchange membrane fuel cell.

15. A method of operating a fuel cell system, said method comprising:
configuring at least one fuel cell to comprise an anode, a cathode, an electrolyte disposed between said anode and said cathode, and a heat regulating circuit configured to flow a heat regulating fluid through said fuel cell, said circuit comprising:
conduit defining a common flowpath, a coolant flowpath and a bypass flowpath; and
at least one flow regulating device disposed in said conduit;
sensing a parameter corresponding to at least one of an ambient temperature, a temperature within said at least one fuel cell or a load on at least one said fuel cell;
manipulating said at least one flow regulating device upon attainment of a threshold value from said sensed parameter; and
introducing a reductant into said anode and an oxidant into said cathode so that said fuel cell produces electricity.

16. The method of claim 15, wherein said at least one flow regulating device comprises a pump and at least one valve, said valve disposed in said conduit in such a location as to selectively permit a flow of said heat regulating fluid through said bypass flowpath.

17. The method of claim 16, wherein said manipulating said at least one flow regulating device comprises manipulating said pump to adjust a rate of flow of said heat regulating fluid through said circuit.

18. The method of claim 15, wherein said manipulating said at least one flow regulating device comprises manipulating said at least one valve.

19. The method of claim 15, wherein said attainment of a threshold value comprises sensing a temperature that is at or below a predetermined value.

20. The method of claim 15, wherein said attainment of a threshold value comprises sensing a load that is at or below a predetermined value, and said manipulating said at least one flow regulating device comprises opening a valve disposed in said bypass flowpath in response to said sensed load.

21. The method of claim 20, wherein said opening a valve disposed in said bypass flowpath in response to said sensed load takes place even if at least one of said ambient temperature and said temperature within said at least one fuel cell exceed a predetermined minimum.

22. The method of claim 15, further comprising:
arranging a supplemental heater to be in thermal communication with said circuit; and
operating said supplemental heater to increase the temperature of said heat regulating fluid flowing through said circuit.
